(19) United States
(12) Patent Application Publication
(10) Pub. No.: US 2005/0155475 A1
(43) Pub. Date: Jul. 21, 2005

(54) Automated double saw

(76) Inventor: Jean-Francois Desrosiers, St-Louis-de-Blanford (CA)

Correspondence Address: GOUDREAU GAGE DUBUC, 800 PLACE VICTORIA, SUITE 3400, MONTREAL, QUEBEC, H4Z 1E9, CA

(21) Appl. No.: 10/843,507

(22) Filed: May 12, 2004

Related U.S. Application Data
(60) Provisional application No. 60/469,792, filed on May 12, 2003.

(51) Int. Cl. B26D 1/18; B26D 5/20

(52) U.S. Cl. 83/76.9; 83/479; 83/488; 83/663

(57) ABSTRACT

A saw has a first saw head and a second saw head and is provided with an optimized structure of the saw heads by reducing a number and dimensions of components thereof, thereby allowing to strike an optimized balance between the cutting path, the cutting height and the dimensions of the cutting bench of the saw. Moreover, the saw of the present invention includes a rear movement mechanism allowing a movement of the blade from the rear end of the saw, which permits to accommodate a blade of an increased diameter, and a crosscut indexation mechanism.

### FIELD OF THE INVENTION

The present invention relates to saws. More specifically, the present invention is concerned with an automated double saw.

### BACKGROUND OF THE INVENTION

In the industry of door and window manufacturing for instance, machining equipment is needed for installation, modification and repair, and efforts are being made to automate available equipment.

It appears that conventional sawing tools fail to meet particular needs in industry manufacturing, especially considering an ongoing rapid evolution in the conception and fabrication processes. For example, vinyl extrusions now appearing on the market have dimensions outgrowing the cutting capacity of current saws and are available with a variety of shapes that challenges the limit of versatility of the conventional tools. In particular, the wide range of thickness now available for vinyl extrusions results in repeated and time-consuming tool adjustments, thereby jeopardizing productivity.

Therefore, there is a need for tools allowing enhanced performances in terms of speed and dimensionality control for example, as well as allowing a wider range of operating conditions in order to adapt to a varied geometry of work pieces, while remaining cost-effective.

### SUMMARY OF THE INVENTION

More specifically, in accordance with the present invention, there is provided a saw for processing a work piece conveyed by a timing belt, comprising a cutting bench; a first saw head mounted on the cutting bench; and a second saw head mounted on the cutting bench; the cutting bench being in contact with a measured surface of the work piece used as a reference surface, and each one of the first and the second saw heads comprising a saw blade.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a general perspective view of a tool according to an embodiment of the present invention;

FIG. 2 are close up perspective views of a saw head of the tool of FIG. 1 with a saw at an angle of 90°;

FIGS. 3 are close up perspective views of a saw head of the tool of FIG. 1 with a saw at an angle of 45°;

FIG. 4 are close up front perspective views of a structural support for the saw of the tool of FIG. 1;

FIG. 5 are close up rear perspective views of the structural support of FIG. 4; and

FIG. 6 are further close up front perspective views of a structural support for the saw of the tool of FIG. 1.

### DESCRIPTION OF EMBODIMENTS OF THE INVENTION

There is provided a saw that alleviates the limitation of the prior art.

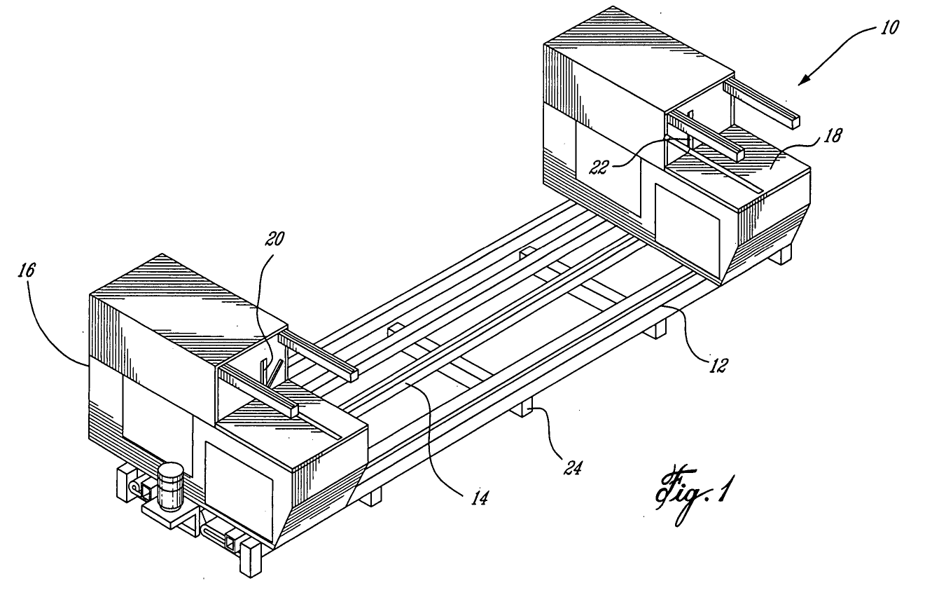

As illustrated in FIG. 1 of the appended drawings, the saw 10 comprises a structural stand 12, a timing belt 14 extending from a first top bench 16 and a second top bench 18, a first saw head 20 mounted on the first top bench 16 and a second saw head 22 mounted on the second top bench 18.

The structural stand 12, which may optionally be provided with adjustable structural support arms 24, is strong and distortion-free. The overall length between the first top bench 16 and the second top bench 18 may be adjusted, of up to 3.5 meters.

The first top bench 16 and the second top bench 18 provide for a cutting bench in contact with a measured surface of a work piece to be processed, which results in an increased precision of cut since the measured surface is used as a reference surface, in contrast with equipment where the work piece has a measured surface thereof upwards.

Obviously the provision of two cutting heads 20, 22 allow an increased cutting rate. One of the two cutting heads 20, 22 is mobile on the timing belt 18, while the other one is fixed.

The present invention comprises optimizing the structure of the cutting head by reducing a number of components thereof and by reducing the dimensions of the remaining components thereof, thereby allowing to strike an optimized balance between the cutting path, the cutting height (as measured by the rake angle) and the dimensions of the cutting bench of the saw.

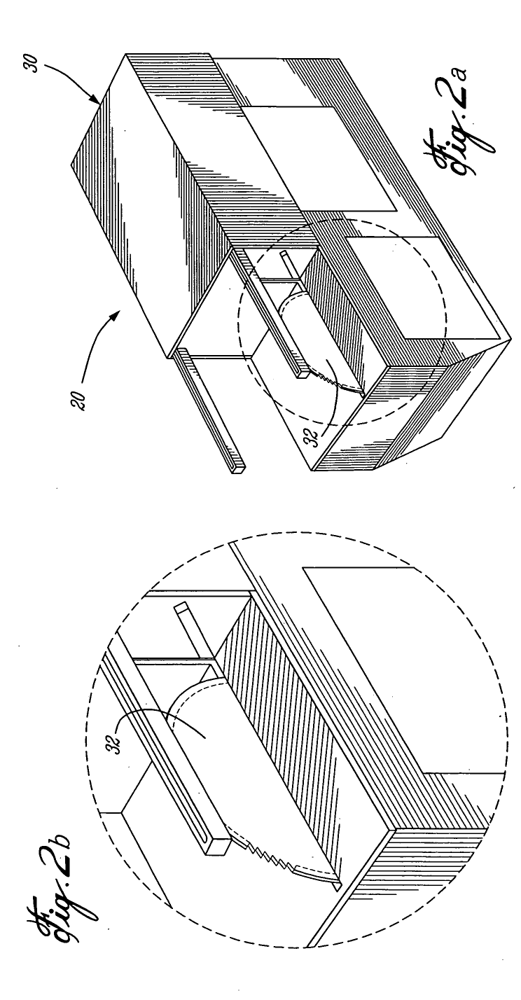

Since the two saw heads 20 and 22 are essentially identical, only the saw head 20 will be described herein for concision purposes, in relation to FIGS. 2 to 6 of the appended drawings.

The saw head 20 comprises a saw housing 30 receiving a saw blade 32.

An increased cutting path, up to 15″ (381 mm) by 25″ (635 mm) is obtained by using larger saw blades 32. The center of the saw blades 32 are positioned lower that the benches 16, 18, which allows a longer travel of the saw blades 32, referred to as the cutting length.

The advance of the saw blade 32 is performed by a hydropneumatic arrangement adjustable by a flow-regulating valve to provide an increased cutting rate and cutting precision by operating simultaneously on both cutting heads.

A rear movement mechanism allows a movement of the blade 32 from the rear end of the saw 10, radially under the cutting bench 16, which permits to accommodate a blade of an increased diameter in comparison to a diameter of 18″ for the diameter of the blades that can currently be mounted on the available tools, without requiring a larger length of the saw housing 30. Moreover, the lowered position center of the blades permits a higher blade diameter and an increased cutting length. Also, the lager diameter allows a larger cutting height.

Thus, it makes possible to determine dimensions of the workpiece to be cut on the basis of the dimensions of the window frame instead of on the basis of the dimensions of the windowpane, in the case of a window application for example. Such a feature results in the elimination of lengthy and fastidious iterative adjustments and corrections that are usually necessary when cutting different workpieces.

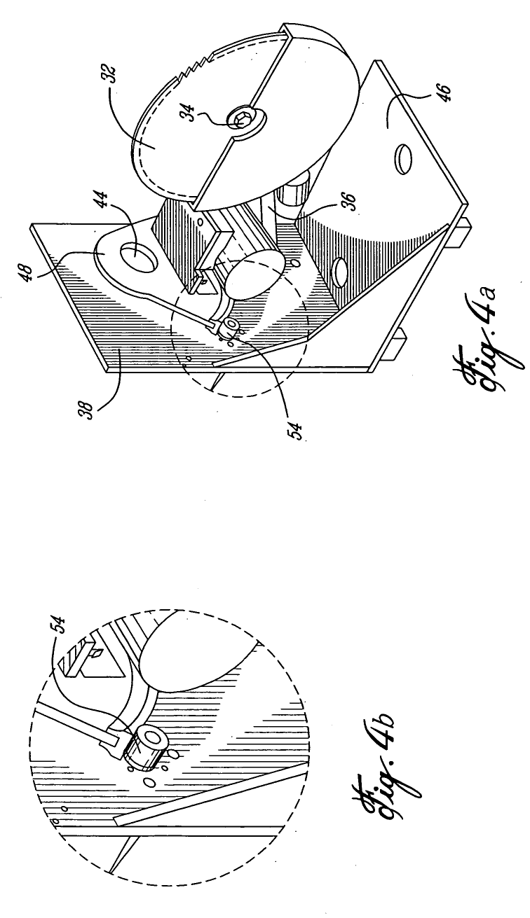

A cross-cut indexation mechanism is provided which will be detailed hereinafter in relation to FIGS. 4 to 6.

Both mechanisms contribute to an enhanced cutting capacity over a widened range of shape, dimension and thickness of objects to be cut, by allowing an increased control of the rotation speeds and of the advance of the saw blade.

A correction mechanism is provided for adjusting and maintaining a reference point of the saw to accommodate the shapes, dimensions and variability in thickness of the work piece. This correction mechanism allows maintaining the reference point of the saw with a constant precision over the range of rake angles and over the cutting length.

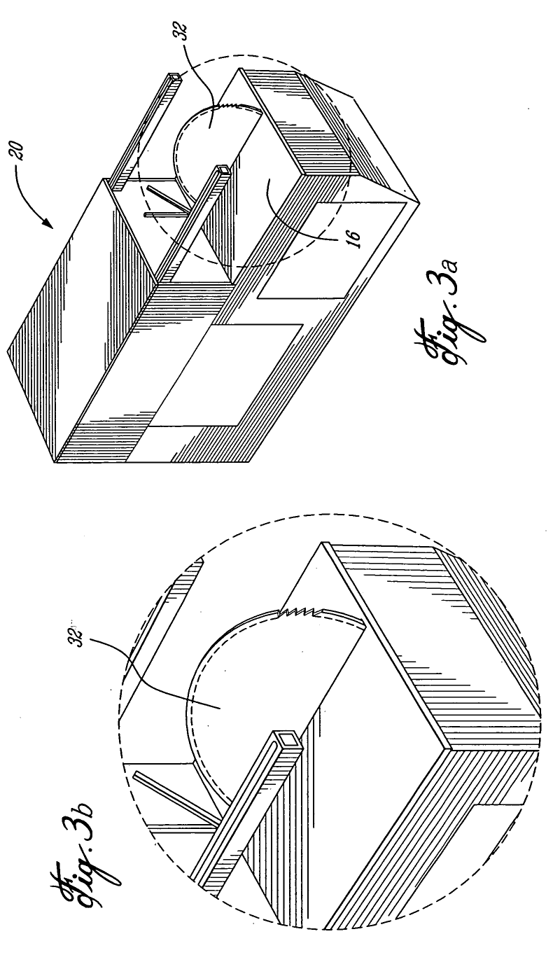

The saw blade 32 may be accommodated for angle cuts between 45° (FIG. 2) and 90° (FIG. 3) to either side, by an indexation mechanism of the blade controlled by a computer.

Within the saw housing 30, the saw blade 32 is mounted by ball bearings on an axis 34 supported by an arm 48 extending from a support 38 mounted on a base 46. The support 48-36 is movable under the action of a cylinder 40 having a first end connected to the base 38 and a second end mounted on the support 42 by a rotating cog mounted on pinion bearings 54, thereby controlling the movement of the support 48-36 around a pivot mount 44.

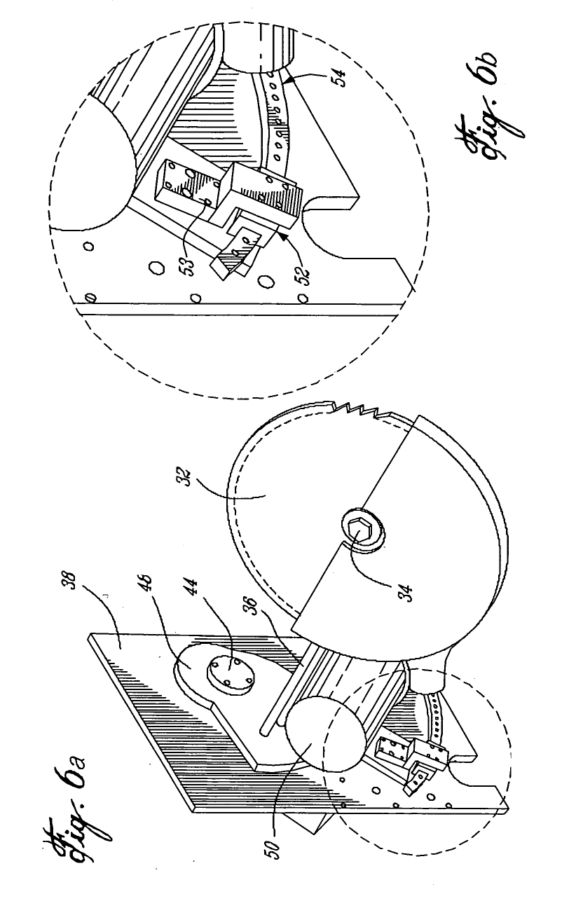

As can be best seen in FIGS. 4 and 6, a structural support of rotation connecting the arm 36 to the support 38 comprises a plate 48 rotatable around the pivot mount 44 and transferring the indexation movement by a rack-and-pinion arrangement 54. Moreover, a cog mechanism 50 allows a precise control of the movement, whereas ball bearings 52 mounted o bearing supports 53 and an arched rail 54 provide stability. The arched rail is a profiled rail treated against corrosion, by fluorination for example. This structural support of rotation also allows adjustment of the cutting angle to accommodate workpieces of varying thickness.

People in the art will appreciate that the present invention allows a rake angle in the range comprised between 45° and 90°, in sharp contrast with existing mechanisms allowing either a rake angle of 45° or a rake angle of 90°.

From the foregoing, it should now be apparent that the saw of the present invention has an optimized cutting head structure, including a structural support for the rotation of the blade and a mechanism of indexation of the rake angle, which allows using blades of a large diameter, for example 20″, 22″ and 24″. Moreover, the structure is adaptable to any dimension of a workpiece and to variability in the thickness of the workpiece of 0.5 mm as compared to 0.15 mm in the current tools.

Prior art tools are limited to use blades of a diameter of 18″ (457,2 mm), and to machine extrusions less than 4″ in thickness, while available extrusions may now have a thickness reaching 4½″ (114,3 mm) at an angle of 45 degrees, which requires, when considering the thickness of the template, a cutting height of up to 5″ (127 mm), i.e. blades of a diameter of 22″ (558,8 mm) or up to 24″ (609,6 mm). The cutting head optimizing of the present invention results in an increase of the cutting path and of the cutting height without modifying the dimensions of the cutting bench, and also in an increase the cutting path without reducing the precision of the reference point of the saw.

The workpiece to be cut by the saw of the present invention may be a plastic profile for a door or a window for example. People in the art will appreciate that the present invention is suitable for cutting aluminum, wood and vinyl profiles and similar material.

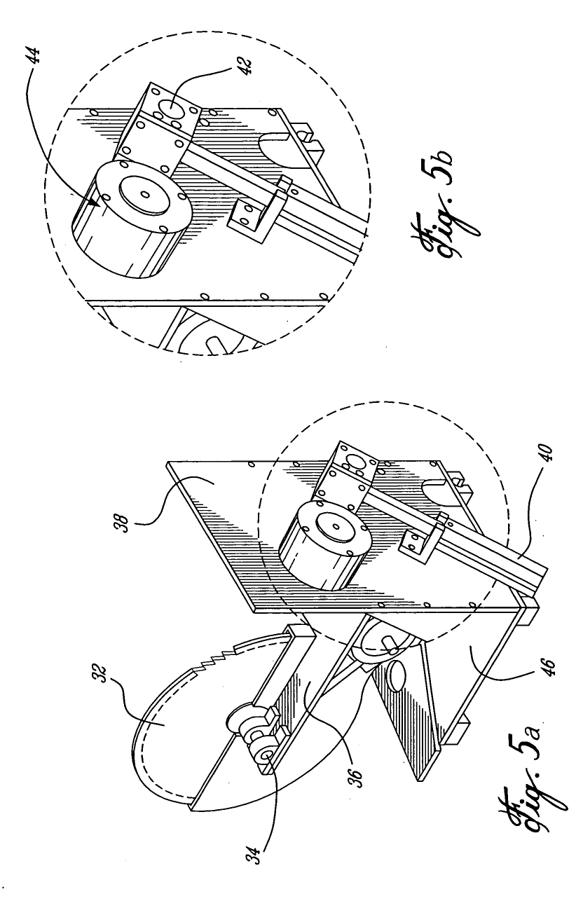

Clearly, a multiple angle saw according to the present invention is capable of cutting round top windows, round top sills, octagon windows. Each saw blade may be stroke independently. Moreover, the angle of each saw blade can be adjusted to a range of angles by replacing the cylinder 40 and the pinion bearings 42 (see FIG. 5) by an electric step motor for example.

The saw blade used herein may be for example carbide tipped circular saw blade.

Interestingly, the tool of the present invention may be fully automated and programmable, and remotely monitored from an operator control station. Automation may be achieved according to custom needs by using versatile electronic components.

People in the art will appreciate that the saw of the present invention benefits from an improved structural support of rotation, of a controlled indexation of the rake angle and of an advantageous mechanism of the blade movement, yielding an enhanced control of the speed and of the advance of the saw blades.

Therefore, the saw of the present invention meets a range of varied needs related to an increasing variety of shapes and dimensions of vinyl extrusions for doors and windows for example, including the range of thickness thereof, in terms of cutting capacity, cutting rate, and precision of cut.

Although the present invention has been described hereinabove by way of embodiments thereof, it may be modified, without departing from the nature and teachings of the subject invention as defined in the appended claims.

1. A saw for processing a work piece conveyed by a timing belt, comprising:
a cutting bench;
a first saw head mounted on said cutting bench; and
a second saw head mounted on said cutting bench;
said cutting bench being in contact with a measured surface of the work piece used as a reference surface, and each one of said first and second saw heads comprising a saw blade.

2. The saw according to claim 1, wherein each saw blade is stroke independently, and an angle of each saw blade is adjusted to a range of angles.

3. The saw according to claim 1, wherein said cutting bench comprises a first top bench and a second top bench, a distance between said first top bench and said second top bench being adjustable; said first saw head being mounted on said first top bench and said second saw head being mounted on said second top bench.

4. The saw according to claim 1, wherein a first one of said first and second saw heads is mobile relative to the timing belt and a second one of said first and second saw heads is fixed.

5. The saw according to claim 2, wherein each saw blade has a center positioned lower that said first top bench and said second top bench.

6. The saw according to claim 4, wherein an advance of the saw blades is performed by a hydropneumatic arrangement adjustable by a flow-regulating valve operating simultaneously on both said first and second saw heads.

7. The saw according to claim 1, further comprising a rear movement mechanism allowing a movement of said saw blade from a rear end portion of the saw, radially under said cutting bench.

8. The saw according to claim 1, further comprising an indexation mechanism.

9. The saw according to claim 1, further comprising a mechanism for maintaining the reference point of the saw with a constant precision over a range of rake angles and over a cutting length thereof.

10. The saw according to claim 8, wherein said indexation mechanism accommodates each saw blade for angle cuts comprised between 45° and 90°.

11. The saw according to claim 10, wherein each saw blade is mounted within a saw housing by ball bearings on an axis supported by an arm extending from a support mounted on a base, said support being movable under an action of a cylinder having a first end connected to said base and a second end mounted on said support by a rotating cog mounted on pinion bearings, thereby controlling a movement of said support around a pivot mount.

12. The saw according to claim 11, wherein said arm and said support are connected by a structural support of rotation comprising a plate rotatable around said pivot mount and transferring an indexation movement by a rack-and-pinion arrangement.

13. The saw according to claim 10, wherein said indexation mechanism comprises an electric step motor.

14. The saw according to claim 1, further comprising a cog mechanism comprising ball bearings mounted on bearing supports and an arched rail.

15. The saw according to claim 1, wherein said blade has a diameter greater than 18″.

16. The saw according to claim 1, wherein the work piece has a thickness of at least 4″.

17. The saw according to claim 1, wherein the work piece has a range of dimensions and a variability in a thickness of 0.5 mm.

18. The saw according to claim 1, wherein the work piece is made in one of aluminum, wood and vinyl.

19. The saw according to claim 1, said saw being fully automated and programmable.

20. The saw according to claim 19, said saw being remotely monitored from an operator control station.
